(19) United States
(12) Patent Application Publication
(10) Pub. No.: US 2026/0048360 A1
(43) Pub. Date: Feb. 19, 2026

(54) SYSTEMS AND METHODS FOR REMOVING CARBON DIOXIDE FROM A CARBON DIOXIDE CONTAINING GAS USING A GEOTHERMAL ENERGY SOURCE

(71) Applicant: Schlumberger Technology Corporation, Sugar Land, TX (US)

(72) Inventors: Shahnawaz Hossain Molla, Cambridge, CA (US); Z. Frank Zheng, Sugar Land, TX (US); Wael Abdallah, Sugar Land, TX (US)

(21) Appl. No.: 19/303,727

(22) Filed: Aug. 19, 2025

Related U.S. Application Data
(60) Provisional application No. 63/684,548, filed on Aug. 19, 2024.

(51) Int. Cl. B01D 53/14; B01D 53/62; B01D 53/78; B01D 53/96; F24T 10/10

(52) U.S. Cl. CPC B01D 53/1425; B01D 53/1475; B01D 53/62; B01D 53/78; B01D 53/96; B01D 2252/204; B01D 2257/504; F24T 10/10

(57) ABSTRACT

A method of removing carbon dioxide from a carbon dioxide-containing gas includes absorbing carbon dioxide from the carbon dioxide-containing gas in an absorber with a lean absorbent to form a loaded absorbent, heating the loaded absorbent using a geothermal energy source and to form a heated loaded absorbent, and providing the heated loading absorbent to a regenerator to form a carbon dioxide-rich gas and the lean absorbent. Related systems and methods of removing carbon dioxide from a carbon dioxide containing gas utilizing a geothermal energy source are also disclosed.

### CROSS REFERENCE TO RELATED APPLICATIONS

This application claims the benefit under 35 U.S.C. § 119 (e) of U.S. Provisional Patent Application Ser. No. 63/684,548, filed Aug. 19, 2024, the disclosure of which is hereby incorporated herein in its entirety by this reference.

### BACKGROUND

Carbon dioxide (CO₂) emissions are a significant contributor to greenhouse gases. For example, byproducts of fossil fuel combustion include carbon dioxide and other greenhouse gas emissions. During the combustion of fossil fuels, such as in electric power plants for the generation of electricity, flue gas from a furnace, boiler, or engine is emitted through one or more stacks to the atmosphere. The flue gas includes one or more pollutants, such as carbon dioxide and other pollutants, including sulfur oxides, nitrogen oxides, and particulate matter. Carbon dioxide is also present in natural gas or biogas generated from anaerobic digesters. The carbon dioxide is conventionally removed from such materials to increase the concentration of methane for subsequent use. In addition to carbon dioxide, emissions from combustion processes may also include other gases, such as carbonyl sulfide (COS), hydrogen sulfide, sulfur oxides (SOₓ gases), and/or nitrogen oxides (NOₓ gases). Point source carbon dioxide emissions from industrial processes, such as fossil fuel-based power generation, cement production, steel production, or other industrial processes, may account for nearly 50 percent of carbon dioxide emissions.

Many approaches have been developed to recover carbon dioxide and other acid gases from post-combustion gases and industrial gases. For example, some methods of capturing carbon dioxide from a flue gas include the use of an absorber in which the flue gas is absorbed by a liquid absorbent that interacts with the carbon dioxide and other acid gases in the flue gas to separate the carbon dioxide and other acid gases from the flue gas and form a carbon dioxide-lean gas having a lower concentration of carbon dioxide than the flue gas. Capturing the carbon dioxide and other acid gases with the absorbent causes the absorbent to become loaded (or enriched; referred to as a “loaded absorbent”) with the carbon dioxide and the other acid gases. The carbon dioxide and other acid gases are subsequently removed from the loaded absorbent to form a carbon dioxide-rich gas. Removal of the carbon dioxide and other acid gases from the loaded absorbent regenerates the absorbent and forms a lean absorbent having a lower concentration of absorbed carbon dioxide than the loaded absorbent. The lean absorbent is circulated back to the absorber, and the process of absorbing the carbon dioxide and other acid gases from the flue gas with the absorbent is continued.

Other methods of capturing carbon dioxide from a flue gas include contacting the flue gas with a sorbent on which the carbon dioxide is physically adsorbed to form a clean gas having a lower concentration of carbon dioxide than the flue gas. After capturing the carbon dioxide with the sorbent, the sorbent is regenerated to remove the adsorbed carbon dioxide and generate a carbon dioxide-rich gas. Whether the carbon dioxide is captured by a liquid absorbent or a physical sorbent, the carbon dioxide-rich gas may be compressed and utilized in an industrial process and/or injected into a subterranean formation (e.g., depleted hydrocarbon reservoirs in the subterranean formation) for storage.

### BRIEF SUMMARY

In some embodiments, a system for removing carbon dioxide from a carbon dioxide-containing gas includes an absorber configured to absorb carbon dioxide from the carbon dioxide-containing gas with a lean absorbent to form a loaded absorbent, a regenerator configured to remove the carbon dioxide from the loaded absorbent, and a closed-loop geothermal heating system configured to circulate at least one of the loaded absorbent or a working fluid in piping in an earth formation to increase a temperature of the loaded absorbent prior to circulating the loaded absorbent to the regenerator.

In some embodiments, a method of removing carbon dioxide from a carbon dioxide-containing gas includes absorbing carbon dioxide from the carbon dioxide-containing gas in an absorber with a lean absorbent to form a loaded absorbent, heating the loaded absorbent using a geothermal energy source and to form a heated loaded absorbent, and providing the heated loading absorbent to a regenerator to form a carbon dioxide-rich gas and the lean absorbent.

In some embodiments, a method of removing carbon dioxide from a carbon dioxide-containing gas comprises absorbing carbon dioxide from the carbon dioxide-containing gas in an absorber with a lean absorbent to form a loaded absorbent, circulating the loaded absorbent in a closed-loop geothermal heating system to increase a temperature of the loaded absorbent using geothermal energy and form a heated loaded absorbent, and circulating the heated loaded absorbent from the closed-loop geothermal heating system to a regenerator.

This summary is provided to introduce a selection of concepts that are further described below in the detailed description. This summary is not intended to identify key or essential features of the claimed subject matter, nor is it intended to be used as an aid in limiting the scope of the claimed subject matter.

Additional features and advantages of embodiments of the disclosure will be set forth in the description which follows, and in part will be obvious from the description, or may be learned by the practice of such embodiments. The features and advantages of such embodiments may be realized and obtained by means of the instruments and combinations particularly pointed out in the appended claims. These and other features will become more fully apparent from the following description and appended claims, or may be learned by the practice of such embodiments as set forth hereinafter.

### BRIEF DESCRIPTION OF DRAWINGS

In order to describe the manner in which the above-recited and other features of the disclosure can be obtained, a more particular description will be rendered by reference to specific implementations thereof which are illustrated in the appended drawings. For better understanding, the like elements have been designated by like reference numbers throughout the various accompanying figures. While some of the drawings may be schematic or exaggerated representations of concepts, at least some of the drawings may be drawn to scale. Understanding that the drawings depict some example implementations, the implementations will be described and explained with additional specificity and detail through the use of the accompanying drawings in which:

FIG. 1 is a simplified schematic illustrating a carbon capture system, according to at least one embodiment of the disclosure;

FIG. 2 is a simplified schematic illustrating another carbon capture system, according to at least one embodiment of the disclosure;

FIG. 3 is a simplified schematic of a system for circulating one or more fluids in a closed-loop geothermal cooling system, according to at least one embodiment of the disclosure; and

FIG. 4 is a simplified flow diagram illustrating a method of removing carbon dioxide from a carbon dioxide-containing gas, according to at least one embodiment of the disclosure.

### DETAILED DESCRIPTION

This disclosure generally relates to devices, systems, and methods for reducing the consumption of energy associated with heating and cooling requirements of carbon capture systems for capturing carbon dioxide from a carbon dioxide-containing gas (e.g., a flue gas). The carbon capture system may include an absorption-based carbon capture system, a sorbent-based carbon capture system, a membrane separation system, a cryogenic system, or another type of carbon capture system. In particular, the disclosure relates to the integration of a geothermal resource to reduce the energy requirements associated with heating and cooling in the carbon capture system.

In some embodiments, the carbon capture system includes an absorption-based carbon capture system. The carbon capture system may include an absorber in which the carbon dioxide-containing gas is contacted with an absorbent (e.g., aqueous solvent, a non-aqueous solvent (NAS)), which may include a nitrogenous base (e.g., an amine) and an organic diluent. The absorbent may also be referred to herein as a “solvent.” The absorbent may absorb carbon dioxide from the carbon dioxide-containing gas and form a carbon dioxide-lean gas and a loaded absorbent that is rich with carbon dioxide (also referred to as a “rich absorbent”). The carbon capture system further includes a regenerator that heats the loaded absorbent to remove the carbon dioxide from the loaded absorbent to form a lean absorbent and a carbon dioxide-rich gas. The lean absorbent may be recycled to the absorber to continuously capture the carbon dioxide from the carbon dioxide-containing gas. The carbon dioxide-rich gas may be utilized in industrial processes to form carbon-containing materials (e.g., ethanol, sustainable fuels, chemicals, mineral aggregates, and/or other materials) and/or may be stored, such as in a subterranean formation.

As noted above, the regenerator is configured to heat the loaded absorbent to facilitate the release of the carbon dioxide therefrom and form the lean absorbent. The lean absorbent is recirculated back to the absorber for absorption of additional carbon dioxide from the carbon dioxide-containing gas. The regenerator may include a reboiler that provides thermal energy (such as in the form of steam) to the loaded absorbent. The thermal energy for regeneration of the loaded absorbent is conventionally a large portion of the overall energy requirement to operate the carbon capture system. Further, when the carbon capture system is coupled to a power plant or another industrial process (e.g., a steam power plant), a significant portion (such as greater than about 20%, such as from about 20%-30%) of the steam generated for use in the industrial process may be used for regeneration of the lean absorbent. Such steam could be used for power generation in the industrial process (e.g., the power plant), but is conventionally used to provide the thermal energy requirement for the regenerator of the carbon capture system, reducing the energy efficiency of the industrial process.

According to embodiments described herein, at least a portion of the thermal energy for regenerating the absorbent is provided from a geothermal energy source. In some embodiments, the loaded absorbent is flowed through a closed-loop geothermal heating system (a direct exchange geothermal system) wherein the loaded absorbent is circulated within a subsurface flowline including closed-loop piping extending from the surface of the earth, through a subsurface geothermal heat zone below the surface of the earth, and back to the surface of the earth. The loaded absorbent exchanges thermal energy with the geothermal energy source as the loaded absorbent circulates below the surface of the earth formation. In other words, in some embodiments, the loaded absorbent exchanges thermal energy directly with the earth formation, such as a geothermal reservoir. After flowing through the subsurface geothermal heat zone in the closed-loop, the loaded absorbent is provided to the regenerator (e.g., proximate an upper portion of the regenerator) and/or to piping coupled to the regenerator. Carbon dioxide may be released from the loaded absorbent as it is heated in the closed-loop piping and/or when it is provided into the regenerator (which may have a lower pressure than the closed-loop piping). For example, responsive to being introduced to the regenerator, the carbon dioxide may be released from the heated loaded absorbent and exit through an outlet proximate an upper portion of the regenerator. Use of renewable geothermal energy to heat the loaded absorbent may reduce the use of fossil fuels or steam generated by fossil fuel combustion to regenerate the loaded absorbent. In some embodiments, heating the loaded absorbent with the geothermal energy reduces the overall energy demand of the carbon capture system and/or increases the power generation of a power plant or other industrial process associated with the carbon capture system.

In some embodiments, geothermal cooling may be used to reduce a temperature of working fluids (e.g., cooling water) and/or of other fluids used within the carbon capture system. For example, geothermal cooling may be used to reduce the temperature of cooling water used in an interstage cooler of the absorber and/or cooling water of one or more coolers of the carbon capture system. In some embodiments, geothermal cooling may utilize a shallow subsurface flowline wherein cooling water that has been used in one or more coolers (e.g., interstage coolers) of the carbon capture system is circulated to a relatively shallow location below the earth formation to be cooled by the earth formation. In other words, the earth formation may be used as a heat sink for the heated cooling water. The relatively shallow location below the earth formation may have a depth that is closer to a surface of the earth formation than the closed-loop geothermal heating system. The circulating cooling water may return from a subsurface location having a lower temperature than the heated cooling water that is provided to the subsurface location. Accordingly, subsurface geothermal cooling may facilitate reducing the temperature of cooling water, improving the energy efficiency of the carbon capture system.

Accordingly, geothermal sources (e.g., geothermal energy sources, geothermal cooling) may be used for providing heating and cooling to different portions of the carbon capture system, reducing the use of non-renewable energy sources (e.g., fossil fuels) in the carbon capture system. For example, geothermal energy may be used to provide thermal energy to the loaded absorbent and/or to the regenerator, reducing the steam requirement of the reboiler of the regenerator. In addition, geothermal sources may be used as a heat sink for cooling water or other heat transfer medium (e.g., cooling medium) used in the carbon capture system.

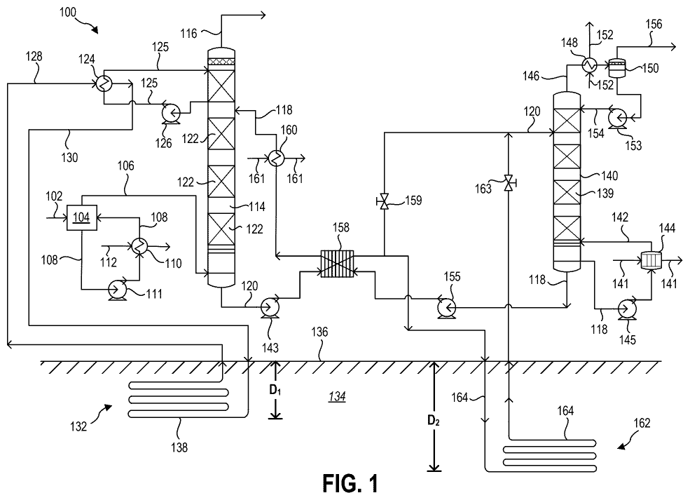

FIG. 1 is a simplified schematic illustrating a carbon capture system 100, according to at least one embodiment of the disclosure. The carbon capture system 100 is configured to remove carbon dioxide and other acid gases from a flue gas 102 of one or more industrial processes, such as power generation. The flue gas 102 may be pretreated in one or more air pollution control devices 104, such as one or more of an electrostatic precipitator (ESP), a flue gas desulfurization (FGD) unit, a selective catalytic NOₓ reduction (SCR) unit, a scrubber, a cooling device to reduce the temperature of the flue gas 102 and/or to condense moisture present in the flue gas 102, or another emission control device. The air pollution control device 104 may form a carbon dioxide-containing gas 106 including fewer particulates, NOₓ, SOₓ, acid gases, and/or other pollutants than the flue gas 102. In some embodiments, the flue gas 102 is contacted with a treatment fluid 108 in the air pollution control devices 104 to remove one or more pollutants from the flue gas 102 and form the carbon dioxide-containing gas 106.

The treatment fluid 108 may exit the bottom of the air pollution control device 104. In some embodiments, the treatment fluid 108 is cooled in a heat exchanger 110. A pump 111 may pump the treatment fluid 108 through the heat exchanger 110 and back to the air pollution control device 104. The heat exchanger 110 may include a cooler, such as a water cooler, wherein cooling water 112 is used as a heat sink to reduce the temperature of the treatment fluid 108.

The carbon dioxide-containing gas 106 may be provided to an absorber 114 where the carbon dioxide in the carbon dioxide-containing gas 106 is at least partially (e.g., substantially) removed from the carbon dioxide-containing gas 106 to form a carbon dioxide-lean (CO₂-lean) gas 116 having a lower concentration of carbon dioxide than the carbon dioxide-containing gas 106. In some embodiments, the absorber 114 is configured to remove from about 85 percent to about 95 percent of the carbon dioxide from the carbon dioxide-containing gas 106, such that from about 5 percent to about 15 percent of the carbon dioxide originally present in the carbon dioxide-containing gas 106 remains in the carbon dioxide-lean gas 116. However, depending on the operating conditions of the absorber 114, the efficiency of carbon dioxide removal from the carbon dioxide-containing gas 106 may be as high as or higher than about 99 percent or even higher.

The carbon dioxide-containing gas 106 may be provided to a lower portion of the absorber 114 and flow countercurrent to an absorbent (e.g., a lean absorbent 118) provided to an upper portion of the absorber 114. The absorber 114 may be configured to provide sufficient contact between the carbon dioxide-containing gas 106 and the lean absorbent 118 to facilitate absorption of carbon dioxide and other acid gases present in carbon dioxide-containing gas 106 by the lean absorbent 118 to form the carbon dioxide-lean gas 116. The lean absorbent 118 may flow downwardly (e.g., such as by gravity) through the absorber 114 countercurrent to the carbon dioxide-containing gas 106. The carbon dioxide-containing gas 106 flows upwardly through the absorber 114 through, for example, one or more packed beds 122. The lean absorbent 118 absorbs carbon dioxide from the carbon dioxide-containing gas 106 to remove carbon dioxide from the carbon dioxide-containing gas 106 and form the carbon dioxide-lean gas 116. Absorption of the carbon dioxide from the carbon dioxide-containing gas 106 loads the lean absorbent 118 with carbon dioxide and forms a loaded absorbent 120 (also referred to as a “carbon dioxide-rich absorbent,” a “loaded solvent,” a “carbon dioxide-rich solvent,” or “a carbon dioxide-loaded solvent”), which exits at a bottom of the absorber 114.

The packing materials of the packed beds 122 may include, for example, stainless steel, structured packing materials, Pall rings, rings of steel or aluminum, other packing materials, or combinations thereof. In some embodiments, the absorber 114 includes trays (e.g., sieve trays, valve trays) through which the lean absorbent 118 falls via gravity as the gas passes upwardly through the trays while contacting the lean absorbent 118.

In some embodiments, the carbon dioxide-lean gas 116 may include at least some of the absorbent entrained therein. In some embodiments, the carbon dioxide-lean gas 116 may be treated with a water wash column and/or an acid wash column to remove at least some of the entrained absorbent from the carbon dioxide-lean gas 116 prior to releasing the carbon dioxide-lean gas to the atmosphere.

The lean absorbent 118 and the loaded absorbent 120 may each include substantially the same material composition, except that the lean absorbent 118 may include less carbon dioxide absorbed therein than the loaded absorbent 120. The lean absorbent 118 and the loaded absorbent 120 may collectively be referred to herein as the “absorbent.” In some embodiments, the lean absorbent 118 and the loaded absorbent 120 include a NAS. Reference to the absorbent herein may refer to the NAS. The NAS may include an organic solvent system that may be partially miscible with water or immiscible with water. The NAS may include polar aprotic solvent systems, protic solvent systems, and mixtures thereof. In some embodiments, the NAS includes a nitrogenous base (e.g., an amine, such as an organic amine) and an organic diluent. In some embodiments, the NAS further includes water.

The nitrogenous base of the NAS may include an amine (e.g., a primary amine, a secondary amine), an amidine, a guanidine (e.g., 1,1,3,3-tetramethylguanidine (“TMG”)), a triazole (e.g., 1,2,3-triazole, 1,2,4-triazole), or combinations thereof. In some embodiments, the nitrogenous base includes a hydrophobic amine. The amine may include one or more of 2-fluoro-N-methylbenzylamine, 3-fluoro-N-methylbenzylamine, 4-fluoro-N-methylbenzylamine, 3,5-difluorobenzylamine, 1,4-diazabicyclo-undec-7-ene (DBU), 1,4-diazabicyclo-2,2,2-octane, piperazine (PZ), triethylamine (TEA), 1,8-diazabicycloundec-7-ene, monoethanolamine (MEA), diethyl amine (DEA), ethylenediamine (EDA), methyldiethanolamine (MDEA), 2-amino 1-propanol (AMP), N-methylbenzylamine (NMBA), 1,3-diamino propane, 1,4-diaminobutane, hexamethylenediamine, 1,7-diaminoheptane, diethanolamine, diisopropylamine (DIPA), 4-aminopyridine, pentylamine, hexylamine, heptylamine, octylamine, nonyl amine, decylamine, tert-octylamine, dioctylamine, dihexylamine, 2-ethyl-1-hexylamine, 2-fluorophenethylamine, 3-fluorophenethylamine, 4-fluorophenethylamine, D-4-fluoro-alpha-methylbenzylamine, L-4-fluoro-alpha-methylbenzylamine, imidazole, benzimidazole, N-methyl imidazole, 1-trifluoroacetylimidazole, or combinations thereof. In some embodiments, the hydrophobic amine includes N-methylbenzylamine.

The organic diluent may include a polyether diluent and may be selected from the group consisting of alcohols, ketones, aliphatic hydrocarbons, aromatic hydrocarbons, nitrogen heterocycles, oxygen heterocycles, aliphatic ethers, cyclic ethers, esters, and amides and mixtures thereof. In some embodiments, the organic diluent includes a polyether diluent, such as a polyethylene glycol dialkyl ether. By way of non-limiting example, the organic diluent may include a polyglycol dimethyl ether, a polyglycol dibutyl ether, or a combination thereof. In some embodiments, the organic diluent includes diethylene glycol dibutyl ether, triethylene glycol dibutyl ether, tetraethylene glycol dibutyl ether, or combinations thereof. In some embodiments, the organic diluent includes triethylene glycol dibutyl ether.

In some embodiments, the nitrogenous base includes NMBA, and the organic diluent includes one or more polyethylene glycol dialkyl ethers. In some such embodiments, the NAS includes NMBA and one or more polyethylene glycol dialkyl ethers, such as one or more of diethylene glycol dibutyl ether, triethylene glycol dibutyl ether, or tetraethylene glycol dibutyl ether.

With continued reference to FIG. 1, the absorber 114 may further include or be operably coupled to one or more interstage coolers 124 configured to cool the absorbent in a reflux 125. The reflux 125 may comprise at least a portion of the absorbent from the absorber 114, such as from an upper portion of the absorber 114. Cooling the absorbent in the reflux 125 may increase the carbon dioxide capacity of the absorbent and facilitate improved capture of carbon dioxide from the carbon dioxide-containing gas 106 by the absorbent. In addition, cooling the reflux 125 may condense absorbent that may have vaporized in the absorber 114 and/or that may be entrained in the carbon dioxide-lean gas 116 in the absorber 114.

The interstage coolers 124 may reduce the temperature (cool) of the reflux 125 using cooling water 128, for example. The reflux 125 may be provided to the interstage coolers 124 by means of a pump 126. The interstage cooler 124 may also be referred to herein as a condenser.

The cooling water 128 may be provided to the interstage cooler 124. In the interstage cooler 124, the cooling water 128 may exchange heat with the reflux 125 to reduce a temperature of the reflux 125. Responsive to cooling the reflux 125 in the interstage cooler 124, the cooling water 128 is heated to a relatively higher temperature to form a heated water stream 130 having a higher temperature than the cooling water 128.

In some embodiments, the cooling water 128 is provided to the interstage cooler 124 after being cooled in an earth formation 134 within a closed-loop geothermal cooling system 132 located within the earth formation 134 below a surface 136 of the earth. The closed-loop geothermal cooling system 132 may be located below the surface 136 of the earth at a depth D1. In some embodiments, the closed-loop geothermal cooling system 132 is a relatively shallow closed-loop geothermal cooling system 132. In some embodiments, the depth D1 may be within a range of from about 5 meters (m) to about 400 m below the surface 136, such as from about 5 m to about 10 m, from about 10 m to about 20 m, from about 20 m to about 50 m, from about 50 m to about 100 m, from about 100 m to about 200 m, from about 200 m to about 300 m, or from about 300 m to about 400 m. However, the disclosure is not so limited, and the depth D1 may be different than that described.

The depth D1 of the closed-loop geothermal cooling system 132 may be selected such that the temperature of the earth formation 134 surrounding and/or proximate the closed-loop geothermal cooling system 132 is less than about 15.6° C. (about 60° F.), less than about 12.8° C. (about 55° F.), less than about 10° C. (about 50° F.), or less than about 7.2° C. (about 45° F.). In some embodiments, the temperature of the earth formation 134 surrounding and/or proximate the closed-loop geothermal cooling system 132 is within a range of from about 10° C. (about 50° F.) to about 15.6° C. (about 60° F.). However, the disclosure is not so limited, and the temperature of the earth formation 134 proximate the closed-loop geothermal cooling system 132 may be different than that described.

The closed-loop geothermal cooling system 132 may be configured to reduce the temperature of the heated water stream 130 to a temperature less than about 15.6° C. (about 60° F.), less than about 12.8° C. (about 55° F.), less than about 10° C. (about 50° F.), or less than about 7.2° C. (about 45° F.). However, the disclosure is not so limited, and the closed-loop geothermal cooling system 132 may reduce the temperature of the heated water stream 130 to a different temperature than that described.

In use and operation, the heated water stream 130 may flow from an exit of the interstage cooler 124 to piping 138 located beneath the surface 136 of the earth. In some embodiments, the piping 138 of the closed-loop geothermal cooling system 132 includes vertical piping (up and down in the view of FIG. 1) to the depth D1 and horizontal piping (left and right and in and out of the page in the view of FIG. 1) at the depth D1.

As the heated water stream 130 circulates within the closed-loop geothermal cooling system 132 within the earth formation 134, the heated water stream 130 exchanges thermal energy with the earth formation 134, such as a geothermal reservoir in the earth formation 134, and is cooled by the earth formation 134 to form the cooling water 128 having a lower temperature than the heated water stream 130. The cooling water 128 is circulated back to above the surface 136 and to the interstage cooler 124 to continue cooling the absorbent in the interstage cooler 124. Thus, geothermal cooling may be configured to provide a heat sink for at least a portion of the carbon capture system 100, such as for cooling water used in the carbon capture system 100. In other words, at least a portion of the thermal management of the carbon capture system 100 may be provided by one or more subsurface formations, such as a shallow geothermal cooling system. Accordingly, in some embodiments, the closed-loop geothermal cooling system 132 facilitates directly cooling the heated water stream 130 using geothermal cooling.

While FIG. 1 has been described and illustrated as cooling the reflux 125 in the interstage cooler 124 with cooling water 128 that circulates in the closed-loop geothermal cooling system 132, the disclosure is not so limited. In some embodiments, the reflux 125 is directly cooled in the piping 138 below the surface 136 in the closed-loop geothermal cooling system 132. In some such embodiments, rather than circulating the cooling water 128 and the heated water stream 130 to and from the interstage cooler 124, the reflux 125 is directly circulated from the absorber 114 to the subsurface piping 138 in the closed-loop geothermal cooling system 132 and returned from the subsurface piping 138 to the absorber 114 having a lower temperature than the reflux 125 removed from the absorber 114. The reflux 125 may be directly cooled in the earth formation 134 in the closed-loop geothermal cooling system 132. Accordingly, the reflux 125 may be circulated through the closed-loop geothermal cooling system 132 to reduce the temperature of the reflux 125.

As described above, the lean absorbent 118 may absorb carbon dioxide from the carbon dioxide-containing gas 106 in the absorber 114 and form the carbon dioxide-lean gas 116 and the loaded absorbent 120. The carbon dioxide-lean gas 116 may be vented from the absorber 114. The loaded absorbent 120 may exit the absorber 114 from a bottom of the absorber 114. The loaded absorbent 120 may be provided to a regenerator 140 (also referred to as a “regenerator column”) via a pump 143. The regenerator 140 is configured to remove the carbon dioxide and other acid gases from the loaded absorbent 120 and form the lean absorbent 118 that is provided to (e.g., recycled to, circulated to) the absorber 114. Thus, the regenerator 140 facilitates removal of carbon dioxide and other acid gases from the loaded absorbent 120 to form the lean absorbent 118. Accordingly, the absorbent may be circulated through the carbon capture system 100 to capture carbon dioxide in the absorber 114, followed by release of the absorbed carbon dioxide in the regenerator 140 and recycling of the lean absorbent 118 to the absorber 114 to continue the process of capturing the carbon dioxide from the carbon dioxide-containing gas 106.

The loaded absorbent 120 may be provided to an upper section of the regenerator 140 and flow downwardly in the regenerator 140. A stream 142 including water vapor and carbon dioxide may be provided to a lower portion of the regenerator 140. The stream 142 may flow upwardly through the regenerator 140 to contact the downwardly flowing loaded absorbent 120 and remove the carbon dioxide and other acid gases from the loaded absorbent 120 to form the lean absorbent 118. Thus, the stream 142 may flow countercurrent to the loaded absorbent 120 in the regenerator 140. A portion of the lean absorbent 118 exiting the bottom of the regenerator 140 may be provided to a reboiler 144, such as by a pump 145. The reboiler 144 heats the portion of the lean absorbent 118 to generate the stream 142. The lean absorbent 118 may be heated in the reboiler 144 with a working fluid 141 comprising, for example, steam or water. The stream 142 may further include volatilized absorbent. In some embodiments, the reboiler 144 heats the lean absorbent 118 to a temperature within a range of from about 100° C. to about 130° C. In some embodiments, the regenerator 140 is configured to heat the loaded absorbent 120 to a temperature within a range of from about 100° C. to about 120° C.

As described above with reference to the absorber 114, the regenerator 140 may include a packed bed 139 including one or more packing materials such as, for example, stainless steel, structured packing materials, Pall rings, rings of steel or aluminum, other packing materials, or combinations thereof. In some embodiments, the regenerator 140 includes trays (e.g., sieve trays, valve trays) through which the absorbent falls via gravity as the stream 142 passes upwardly through the trays while contacting the loaded absorbent 120.

With continued reference to FIG. 1, regenerating the absorbent in the regenerator 140 releases the carbon dioxide from the loaded absorbent 120 and forms a carbon dioxide-rich gas 146 that exits the top of the regenerator 140. In some embodiments, vapors entrained in the carbon dioxide-rich gas 146 are condensed in a cooler (e.g., condenser) 148 and collected in a vessel (e.g., a decanter) 150. For example, the cooler 148 may be configured to condense the carbon dioxide-rich gas 146 using cooling water 152 or another thermal transfer medium. A reflux 154 including a liquid comprising the condensed vapors may be recycled to the regenerator 140. In some embodiments, a pump 153 circulates the reflux 154 from the vessel 150 back to the regenerator 140. In some embodiments, the reflux 154 includes water. Vapors from the vessel 150 include a carbon dioxide product 156 from which water and other liquids have been removed. In some embodiments, the cooling water 152 may be circulated through the closed-loop geothermal cooling system 132 to reduce the temperature of the cooling water 152 after the cooling water 152 is heated by the carbon dioxide-rich gas 146 in the cooler 148, as described above with reference to the cooling water 128.

The carbon dioxide product 156 may be further processed to remove any impurities (e.g., absorbent, steam) from the carbon dioxide product 156. The carbon dioxide product may have a higher concentration of carbon dioxide than the flue gas 102. The carbon dioxide product 156 may be stored in an earth formation (e.g., sequestered), may be used in the manufacture of other materials (e.g., ethanol, sustainable aviation fuel, chemicals, mineral aggregates, and/or other materials), or combinations thereof.

After leaving the bottom of the regenerator 140, the lean absorbent 118 may be provided to the absorber 114. The lean absorbent 118 exiting the regenerator 140 may have a relatively high temperature that may be unsuitable for absorbing carbon dioxide in the absorber 114. In some embodiments, a pump 155 pumps the lean absorbent 118 to a heat exchanger 158 (referred to as a lean/rich heat exchanger) configured to heat the loaded absorbent 120 from the bottom of the absorber 114 with the lean absorbent 118 from the bottom of the regenerator 140 and cool the lean absorbent 118 entering the absorber 114. While FIG. 1 illustrates the pump 155 upstream of the heat exchanger 158, in some embodiments the pump 155 is downstream of the heat exchanger 158 and the lean absorbent 118 flows from the bottom of the regenerator 140 through the heat exchanger 158 to the pump 155.

In some embodiments, the lean absorbent 118 may be further cooled in a cooler 160 to lower a temperature of the lean absorbent 118 and increase a carbon dioxide capacity of the lean absorbent 118 in the absorber 114. In some embodiments, the cooler 160 is substantially the same as the interstage cooler 124. The cooler 160 may utilize cooling water 161 for reducing the temperature of the lean absorbent 118 prior to the lean absorbent 118 entering the absorber 114. In some embodiments, the cooling water 161 may be circulated through the closed-loop geothermal cooling system 132 to reduce the temperature of the cooling water 161 after the cooling water 161 is heated by the lean absorbent 118 in the cooler 160, as described above with reference to the cooling water 128.

As described above, the regenerator 140 is configured to increase the temperature of the loaded absorbent 120 to release absorbed carbon dioxide therefrom and form the lean absorbent 118. In some embodiments, the carbon capture system 100 includes a closed-loop geothermal heating system 162 for providing at least some of the thermal energy for the regenerator 140 and/or regeneration of the absorbent and increasing the temperature of the loaded absorbent 120. In some embodiments, the loaded absorbent 120 heated by the lean absorbent 118 in the heat exchanger 158 is provided to the closed-loop geothermal heating system 162 to heat the loaded absorbent 120 using geothermal energy. In some embodiments, rather than circulating from the heat exchanger 158 directly to the regenerator 140, the loaded absorbent 120 flows from the heat exchanger 158 to the closed-loop geothermal heating system 162. The closed-loop geothermal heating system 162 may heat the loaded absorbent 120 using a geothermal energy source. A temperature of the loaded absorbent 120 may increase below the surface 136 of the earth formation 134 within the closed-loop geothermal heating system 162 rather than in a separate heat exchanger located above the surface 136. Accordingly, the closed-loop geothermal heating system 162 may reduce the amount of energy consumed by the reboiler 144 during operation of the regenerator 140. The loaded absorbent 120 heated by the geothermal energy source in the closed-loop geothermal heating system 162 may be provided to the regenerator 140 and may be referred to as a heated loaded absorbent 120. In some embodiments, the loaded absorbent 120 is directly heated in the closed-loop geothermal heating system 162. In some such embodiments, the loaded absorbent 120 is heated in the earth formation 134 in the closed-loop geothermal heating system 162 without circulation of a separate working fluid.

More particularly, in some embodiments, after exiting the heat exchanger 158 and prior to entering the regenerator 140, the loaded absorbent 120 may be circulated through the closed-loop geothermal heating system 162 to increase the temperature of the loaded absorbent 120 prior to circulating to the regenerator 140. Since the loaded absorbent 120 enters the regenerator 140 at a higher temperature compared to embodiments not including the closed-loop geothermal heating system 162, the presence of the closed-loop geothermal heating system 162 reduces the energy requirement of the reboiler 144 compared to embodiments without the closed-loop geothermal heating system 162. In some embodiments, the carbon capture system 100 includes a valve 159 configured to allow at least a portion of the loaded absorbent 120 exiting the heat exchanger to bypass the closed-loop geothermal heating system 162 and flow from the heat exchanger 158 directly to the reboiler 144. In some embodiments, the valve 159 is closed such that all of the loaded absorbent 120 exiting the heat exchanger 158 flows through the closed-loop geothermal heating system 162. In some embodiments, the piping 164 includes one or more valves 163 to control a flow rate of the loaded absorbent 120 through the closed-loop geothermal heating system 162.

In some embodiments, the closed-loop geothermal heating system 162 includes piping 164 extending from, for example, piping between the heat exchanger 158 and the inlet to the regenerator 140 and a subsurface location below the surface 136 of the earth formation 134. The piping 164 may provide the loaded absorbent 120 exiting the heat exchanger 158 to the closed-loop geothermal heating system 162 below the surface 136 of the earth formation 134 where the loaded absorbent 120 circulates through the piping 164 at a depth D2 below the surface 136. In some embodiments, the piping 164 of the closed-loop geothermal heating system 162 includes vertical piping to the depth D2 and horizontal piping at the depth D2 (or within a given distance from the depth D2). Accordingly, in some embodiments, the closed-loop geothermal heating system 162 facilitates directly heating the loaded absorbent 120 in the earth formation 134 using geothermal energy.

While the closed-loop geothermal heating system 162 has been shown as having a particular configuration, the disclosure is not so limited. In some embodiments, the closed-loop geothermal heating system 162 includes a deep borehole heat exchanger (DBHE).

In some embodiments, the pump 143 is configured to provide sufficient pressure to the loaded absorbent 120 to circulate from the outlet of the absorber 114, through the heat exchanger 158, from the heat exchanger 158 through the piping 164 of the closed-loop geothermal heating system 162 below the surface 136, back to above the surface 136 and to the inlet of the regenerator 140 (or to piping in fluid communication with the inlet of the regenerator 140, such as piping between the heat exchanger 158 and the regenerator 140). Thus, the loaded absorbent 120 may be directed into the closed-loop geothermal heating system 162 in the earth formation 134 below the surface 136 and geothermally heated to increase the temperature of the loaded absorbent 120 and facilitate regeneration thereof. In some embodiments, the carbon capture system 100 includes one or more additional pumps to facilitate pumping the loaded absorbent 120 through the heat exchanger 158 and the closed-loop geothermal heating system 162 to the regenerator 140.

As described above, the closed-loop geothermal heating system 162 may be located at a depth D2 below the surface 136 of the earth formation 134. The depth D2 may be greater than the depth D1 of the closed-loop geothermal cooling system 132. In other words, the closed-loop geothermal cooling system 132 (or the piping 138 of the closed-loop geothermal cooling system 132) may be located closer to the surface 136 of the earth formation 134 than the closed-loop geothermal heating system 162 (or the piping 164 of the closed-loop geothermal heating system 162). In some embodiments, the depth D2 may be selected such that the temperature of the earth formation 134 proximate the piping 164 is greater than about 80° C. (about 176° F.), greater than about 90° C. (about 194° F.), greater than about 100° C. (about 212° F.), greater than about 110° C. (about 230° F.), greater than about 120° C. (about 248° F.), greater than about 130° C. (about 266° F.), or even greater than about 140° C. (about 284° F.). Circulating the loaded absorbent 120 through the closed-loop geothermal heating system 162 may cause the temperature of the loaded absorbent 120 to increase to a temperature greater than about 80° C. (about 176° F.), greater than about 90° C. (about 194° F.), greater than about 100° C. (about 212° F.), greater than about 110° C. (about 230° F.), or greater than about 120° C. (about 248° F.). In some embodiments, the closed-loop geothermal heating system 162 is configured to increase the temperature of the loaded absorbent 120 to a temperature within a range of from about 80° C. (about 176° F.) to about 120° C. (about 248° F.), such as from about 80° C. (about 176° F.) to about 100° C. (about 212° F.), or from about 100° C. (about 212° F.) to about 120° C. (about 248° F.). However, the disclosure is not so limited, and the temperature of the earth formation 134 and/or the temperature of the loaded absorbent 120 heated by the earth formation 134 in the closed-loop geothermal heating system 162 may be different than those described.

In some embodiments, the closed-loop geothermal heating system 162 provides substantially all of the energy for regenerating the loaded absorbent 120 to form the lean absorbent 118. In some such embodiments, the carbon capture system 100 may not include the reboiler 144. In some embodiments, the closed-loop geothermal heating system 162 provides a portion of the energy for regenerating the loaded absorbent 120.

The depth D2 may be greater than about 500 m, such as greater than about 750 m, greater than about 1,000 m, greater than about 1,500 m, greater than about 2,000 m, greater than about 2,500 m, greater than about 3,000 m, or greater than about 4,000 m. In some embodiments, the depth D2 is within a range of from about 1,000 m to about 3,000 m. However, the disclosure is not so limited, and the depth D2 may be different than that described.

Accordingly, the closed-loop geothermal heating system 162 is configured to facilitate directly heating the loaded absorbent 120 with geothermal energy to increase the temperature of the loaded absorbent 120 and to regenerate the loaded absorbent 120 and reduce (e.g., eliminate) the energy requirement of the regenerator 140 and/or the reboiler 144. The loaded absorbent 120 may be directly heated with geothermal energy in the earth formation 134.

While the carbon capture system 100 has been described and illustrated as including the closed-loop geothermal heating system 162 for increasing the temperature of the loaded absorbent 120, the disclosure is not so limited. In some embodiments, the carbon capture system 100 includes a heat exchanger configured to facilitate thermal transfer between the loaded absorbent 120 and a fluid circulated from the earth formation 134. For example, the loaded absorbent 120 may be heated by direct use of geothermal energy or deep geothermal energy. In some embodiments, water from within a reservoir within the earth formation 134 may be circulated to the heat exchanger to heat the loaded absorbent 120 in the heat exchanger and/or may be circulated to the reboiler 144. After heat transfer, the cooled water may be circulated back to the earth formation 134.

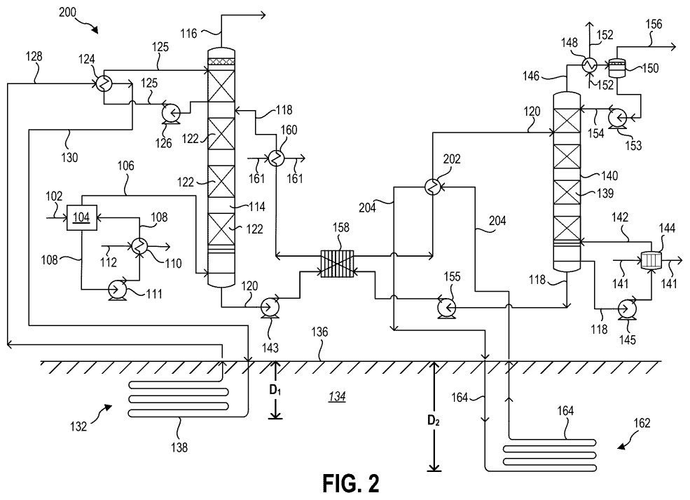

In some embodiments, the loaded absorbent 120 is heated by means of a working fluid circulating within the closed-loop geothermal heating system 162 rather than being directly heated by circulation in the closed-loop geothermal heating system 162. FIG. 2 is a simplified schematic illustrating a carbon capture system 200, according to at least one embodiment of the disclosure.

The carbon capture system 200 is substantially the same as the carbon capture system 100 described above, except that the carbon capture system 200 includes a heat exchanger 202 configured to receive the loaded absorbent 120 from the heat exchanger 158. A working fluid 204 may be circulated in the closed-loop geothermal heating system 162 to provide thermal energy to and increase the temperature of the loaded absorbent 120. For example, the working fluid 204 flowing to the heat exchanger 202 may facilitate increasing the temperature of the loaded absorbent 120 in the heat exchanger 202. The working fluid 204 may be cooled by the loaded absorbent 120 in the heat exchanger 202, and the working fluid 204 exiting the heat exchanger 202 may be circulated back to the closed-loop geothermal heating system 162 in the earth formation 134 to increase the temperature of the working fluid 204 prior to circulating back to the heat exchanger 202.

In some embodiments, the working fluid 204 is circulated in a closed-loop to provide energy thereto, as described with reference to the loaded absorbent 120 and the closed-loop geothermal heating system 162. In some embodiments, the working fluid 204 is circulated within a separate closed-loop geothermal heating system 162 to heat the working fluid 204 in the earth formation 134 using geothermal energy. In some embodiments, rather than circulating the working fluid 204, the lean absorbent 118 that flows through the reboiler 144 is provided to the closed-loop geothermal heating system to be heated in the earth formation 134 directly using geothermal energy. Accordingly, the closed-loop geothermal heating system 162 may be configured to circulate at least one of the loaded absorbent 120 (as described with reference to FIG. 1) or the working fluid 204.

The geothermal energy source, such as both of the closed-loop geothermal heating system 162 and the closed-loop geothermal cooling system 132 may be local geothermal sources that are local to the carbon capture system 100. Accordingly, at least some of the energy for regeneration of the loaded absorbent 120 to form the lean absorbent 118 may be provided from a geothermal energy source located within the earth formation 134. The geothermal energy source may be located proximate (e.g., within 1 kilometer (km), within 5 km, within 10 km from) the carbon capture system 100. In some embodiments, the geothermal energy source is located less than about 10 km, such as less than about 5 km, or less than about 1 km from the carbon capture system 100 and/or at least one component (e.g., at least one of the absorber 114 or the regenerator 140) of the carbon capture system 100.

As described above, a temperature of the loaded absorbent 120 may be increased by the geothermal energy while the loaded absorbent 120 is circulated in the closed-loop geothermal heating system 162. In some embodiments, as the loaded absorbent 120 is heated in the closed-loop geothermal heating system 162, at least some of the absorbed carbon dioxide in the loaded absorbent may desorb (be released) while the loaded absorbent is circulating in the closed-loop geothermal heating system 162, such as below the surface 136. In some embodiments, the carbon dioxide is released from the loaded absorbent 120 responsive to entering the regenerator 140, which may have a lower pressure than the piping in which the loaded absorbent is circulated.

While FIG. 1 has been described and illustrated as including only one closed-loop geothermal cooling system 132 (e.g., for use as a heat sink for the cooling water of the interstage cooler 124 (to cool the heated water stream 130)), the disclosure is not so limited. In some embodiments, a closed-loop geothermal cooling system is configured for use as a heat sink for cooling water for one or more other systems of the carbon capture system 100, such as for one or more of the heat exchanger 110, the cooler 160, the cooler 148, and/or a water wash cooler. In some embodiments, each of the heat exchanger 110, the cooler 160, the cooler 148, and/or the water wash cooler may include or be associated with a separate closed-loop geothermal cooling system as one another. In some embodiments, the cooling water associated with one or more of (e.g., each of) the interstage cooler 124, the heat exchanger 110, the cooler 160, the cooler 148, and/or the water wash cooler is combined in a manifold, provided to the one closed-loop geothermal cooling system 132 to cool the cooling water, and circulated back to each of the respective one or more of the interstage cooler 124, the heat exchanger 110, the cooler 160, the cooler 148, and/or the water wash cooler. Accordingly, in some embodiments, in addition to the cooling water 128, one or more of the cooling water 112, the cooling water 161, or the cooling water 152 may be circulated within a closed-loop geothermal cooling system, such as the closed-loop geothermal cooling system 132.

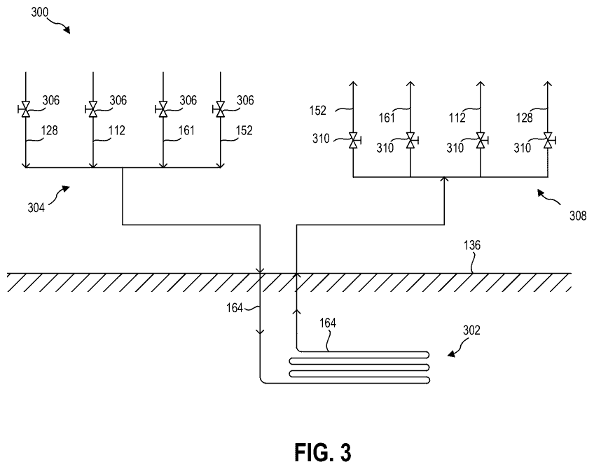

In some embodiments, the carbon capture system 100 includes more than one closed-loop geothermal cooling system 132, such as a closed-loop geothermal cooling system 132 for each type of working fluid (e.g., for cooling water, for other working fluids). FIG. 3 is a simplified schematic of a system 300 for circulating one or more fluids, such as one or more of the cooling water 128, the cooling water 112, the cooling water 161, or the cooling water 152 in a closed-loop geothermal cooling system 302, in accordance with at least one embodiment of the disclosure. The closed-loop geothermal cooling system 302 may be the same as the closed-loop geothermal cooling system 132 described above.

With reference to FIG. 3, the system 300 may include a first manifold 304 in fluid communication with an inlet to the closed-loop geothermal cooling system 302 and configured to provide a flow of fluid to the closed-loop geothermal cooling system 302 below the surface 136 of the earth formation 134. One or more of the cooling water 128, the cooling water 112, the cooling water 161, or the cooling water 152 may be in fluid communication with the first manifold 304 (also referred to as a “supply manifold” or an “inlet manifold”). Valves 306 may be configured to control a flow rate of each of the cooling water 128, the cooling water 112, the cooling water 161, or the cooling water 152 through the first manifold 304. The fluid may flow from the first manifold 304, through the closed-loop geothermal cooling system 302 beneath the surface 136 and to a second manifold 308 (also referred to as a “return manifold” or an “outlet manifold”). The fluid may flow from the second manifold 308 to each of the cooling water 128, the cooling water 112, the cooling water 161, and the cooling water 152 and return to the respective one of the interstage cooler 124, the heat exchanger 110, the cooler 160, and the cooler 148. Valves 310 may be configured to control a flow rate of the fluid returning to each of the respective interstage cooler 124, the heat exchanger 110, the cooler 160, and the cooler 148.

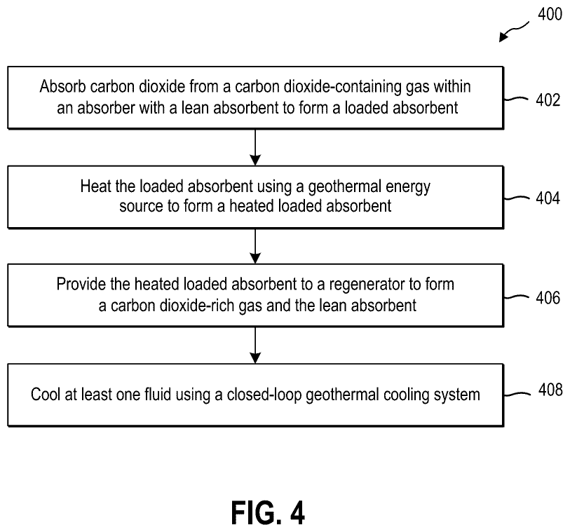

FIG. 4 is a simplified flow diagram illustrating a method 400 of removing carbon dioxide from a carbon dioxide-containing gas, according to at least one embodiment of the disclosure. The method 400 includes absorbing carbon dioxide from a carbon-containing gas in an absorber with a lean absorbent to form a loaded absorbent, as shown in act 402. The absorber may be the same as the absorber 114 described above with reference to FIG. 1. The carbon dioxide may be absorbed with an absorbent, such as the lean absorbent 118. Absorbing the carbon dioxide with the lean absorbent may form the loaded absorbent loaded with carbon dioxide.

The method 400 may further include heating the loaded absorbent using a geothermal energy source to form a heated loaded absorbent, as shown in act 404. In some embodiments, act 404 includes circulating the loaded absorbent within a closed-loop geothermal heating system to heat the loaded absorbent with the geothermal energy source and form the heated loaded absorbent. In some embodiments, act 404 includes circulating a working fluid in the closed-loop geothermal heated system to heat the working fluid. The heated working fluid may be provided to a heat exchanger configured to facilitate heat transfer between the heated working fluid and the loaded absorbent to form the heated loaded absorbent. After passing through the heat exchanger, the working fluid may be circulated back to the closed-loop geothermal heating system to be reheated and circulated back to the heat exchanger to continuously provide thermal energy to the loaded absorbent.

The method 400 may further include providing the heated loaded absorbent to a regenerator to form a carbon dioxide-rich gas and the lean absorbent, as shown in act 406. The regenerator may be the same as the regenerator 140 described above. In some embodiments, heating the loaded absorbent in act 404 forms the lean absorbent. In some embodiments, heating the loaded absorbent in act 404 and providing the heated loaded absorbent to the regenerator (e.g., having a lower pressure than the closed-loop geothermal heating system) facilitates release of the absorbed carbon dioxide from the loaded absorbent to form the lean absorbent.

With continued reference to FIG. 4, in some embodiments, the method 400 further includes cooling at least one fluid using a closed-loop geothermal cooling system, as shown in act 408. The closed-loop geothermal cooling system may be the same as the closed-loop geothermal cooling system 132 described with reference to FIG. 1. The at least one fluid may include at least one of the reflux 125, the lean absorbent 118, the treatment fluid 108, or the carbon dioxide-rich gas 146. In some embodiments, the at least one fluid is directly cooled in the closed-loop geothermal cooling system, such as by circulating the at least one fluid in the closed-loop geothermal cooling system to beneath the surface of the earth formation. In some embodiments, the at least one fluid is cooled using a working fluid that is circulated in the closed-loop geothermal cooling system. The working fluid may include, for example, cooling water, such as one or more of the cooling water 112, the cooling water 128, the cooling water 161, or the cooling water 152. The working fluid may cool the at least one fluid in a heat exchanger, as described above with reference to the interstage cooler 124, the heat exchanger 110, the cooler 160, and the cooler 148.

Accordingly, the geothermal energy may be provided to the loaded absorbent 120 to facilitate increasing the temperature of the loaded absorbent 120, regeneration of the loaded absorbent 120, and/or reducing the energy requirement of the reboiler 144 for regeneration of the loaded absorbent 120. In addition, conventional carbon dioxide capture processes often require several hours for start-up and shutdown procedures. However, during start-up and shutdown procedures, the steam supply from a powerplant or other industrial processes that use fossil fuels from which the carbon dioxide is captured by the carbon capture system 100 is generally unsteady and requires several hours before reaching equilibrium where the steam is provided at a constant and desired rate for the carbon capture system 100. Accordingly, in conventional carbon capture systems, it may take hours before the loaded absorbent 120 is heated to a sufficient temperature to facilitate regeneration of the loaded absorbent 120 to form the lean absorbent 118 such that the absorbent can be continuously used for the carbon dioxide capture. In addition, conventional carbon capture systems may utilize up to about 20 percent or 30 percent of the steam generated in industrial processes for regeneration of the loaded absorbent 120. Such steam could otherwise be used to generate power. Utilizing the geothermal energy with the closed-loop geothermal heating system 162 facilitates reducing the steam from industrial processes used for the carbon capture system, and reduces bottlenecks associated with steam use in carbon capture systems.

According to embodiments of the carbon capture system 100 including the closed-loop geothermal heating system 162 described herein, the absorbent can be preheated with a geothermal energy source and the temperature of the absorbent may be maintained at a desired steady temperature before carbon dioxide capture begins, reducing the start-up time and energy consumption of the carbon capture system 100. In addition, during shutdown procedures (e.g., when the industrial facility (e.g., power plant) shuts down), the energy for regeneration of the loaded absorbent 120 may be provided by the geothermal energy source.

While the geothermal energy sources have been described and illustrated as being used in a carbon capture system that utilizes a circulating absorbent, the disclosure is not so limited. The geothermal energy and each of the closed-loop geothermal heating system 162 and the closed-loop geothermal cooling system 132 may be used in other processes for carbon dioxide separation and capture, such as adsorption with a physical sorbent, membrane separation, cryogenic processes, or other processes.

One or more specific embodiments of the present disclosure are described herein. These described embodiments are examples of the presently disclosed techniques. Additionally, in an effort to provide a concise description of these embodiments, not all features of an actual embodiment may be described in the specification. It should be appreciated that in the development of any such actual implementation, as in any engineering or design project, numerous embodiment-specific decisions will be made to achieve the developers' specific goals, such as compliance with system-related and business-related constraints, which may vary from one embodiment to another. Moreover, it should be appreciated that such a development effort might be complex and time consuming, but would nevertheless be a routine undertaking of design, fabrication, and manufacture for those of ordinary skill having the benefit of this disclosure.

The articles “a,” “an,” and “the” are intended to mean that there are one or more of the elements in the preceding descriptions. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features. For example, any element described in relation to an embodiment herein may be combinable with any element of any other embodiment described herein. Numbers, percentages, ratios, or other values stated herein are intended to include that value, and also other values that are “about” or “approximately” the stated value, as would be appreciated by one of ordinary skill in the art encompassed by embodiments of the present disclosure. A stated value should therefore be interpreted broadly enough to encompass values that are at least close enough to the stated value to perform a desired function or achieve a desired result. The stated values include at least the variation to be expected in a suitable manufacturing or production process, and may include values that are within 5%, within 1%, within 0.1%, or within 0.01% of a stated value.

A person having ordinary skill in the art should realize in view of the present disclosure that equivalent constructions do not depart from the spirit and scope of the present disclosure, and that various changes, substitutions, and alterations may be made to embodiments disclosed herein without departing from the spirit and scope of the present disclosure. Equivalent constructions, including functional “means-plus-function” clauses are intended to cover the structures described herein as performing the recited function, including both structural equivalents that operate in the same manner, and equivalent structures that provide the same function. It is the express intention of the applicant not to invoke means-plus-function or other functional claiming for any claim except for those in which the words ‘means for’ appear together with an associated function. Each addition, deletion, and modification to the embodiments that falls within the meaning and scope of the claims is to be embraced by the claims.

The terms “approximately,” “about,” and “substantially” as used herein represent an amount close to the stated amount that still performs a desired function or achieves a desired result. For example, the terms “approximately,” “about,” and “substantially” may refer to an amount that is within less than 5% of, within less than 1% of, within less than 0.1% of, and within less than 0.01% of a stated amount. Further, it should be understood that any directions or reference frames in the preceding description are merely relative directions or movements. For example, any references to “up” and “down” or “above” or “below” are merely descriptive of the relative position or movement of the related elements.

The present disclosure may be embodied in other specific forms without departing from its spirit or characteristics. The described embodiments are to be considered as illustrative and not restrictive. The scope of the disclosure is, therefore, indicated by the appended claims rather than by the foregoing description. Changes that come within the meaning and range of equivalency of the claims are to be embraced within their scope.

What is claimed is:

1. A method of removing carbon dioxide from a carbon dioxide-containing gas, the method comprising:
absorbing carbon dioxide from the carbon dioxide-containing gas in an absorber with a lean absorbent to form a loaded absorbent;
heating the loaded absorbent using a geothermal energy source and to form a heated loaded absorbent; and
providing the heated loading absorbent to a regenerator to form a carbon dioxide-rich gas and the lean absorbent.

2. The method of claim 1, wherein heating the loaded absorbent using a geothermal energy source comprises circulating the loaded absorbent within a closed-loop geothermal heating system.

3. The method of claim 1, wherein circulating the loaded absorbent within a closed-loop geothermal heating system comprises circulating substantially all of the loaded absorbent flowing from the absorber to the regenerator through the closed-loop geothermal heating system.

4. The method of claim 1, wherein heating the loaded absorbent using a geothermal energy source comprises:
circulating a working fluid in a closed-loop geothermal heating system; and
heating the loaded absorbent in a heat exchanger using the working fluid.

5. The method of claim 1, further comprising cooling at least one fluid in a closed-loop geothermal cooling system.

6. The method of claim 5, wherein the at least one fluid comprises a reflux of the absorber or cooling water.

7. The method of claim 1, wherein the geothermal energy source is less than about 10 km from at least one of the absorber or the regenerator.

8. The method of claim 1, wherein absorbing carbon dioxide from the carbon dioxide-containing gas in an absorber with a lean absorbent includes absorbing carbon dioxide with an amine absorbent.

9. The method of claim 1, wherein heating the loaded absorbent using a geothermal energy source comprises heating the loaded absorbent to a temperature greater than about 100° C.

10. The method of claim 1, further comprising cooling at least a portion of the lean absorbent in the absorber with cooling water in an interstage cooler.

11. The method of claim 10, further comprising circulating the cooling water in a closed-loop geothermal cooling source within an earth formation, the closed-loop geothermal cooling source closer to a surface of the earth formation than the geothermal energy source for heating the loaded absorbent.

12. The method of claim 1, wherein circulating the loaded absorbent within a closed-loop geothermal heating system includes releasing at least some of the carbon dioxide from the loaded absorbent in the closed-loop geothermal heating system.

13. A system for removing carbon dioxide from a carbon dioxide-containing gas, the system comprising:
an absorber configured to absorb carbon dioxide from the carbon dioxide-containing gas with a lean absorbent to form a loaded absorbent;
a regenerator configured to remove the carbon dioxide from the loaded absorbent; and
a closed-loop geothermal heating system configured to circulate at least one of the loaded absorbent or a working fluid in piping in an earth formation to increase a temperature of the loaded absorbent prior to circulating the loaded absorbent to the regenerator.

14. The system of claim 13, further comprising a heat exchanger configured to facilitate thermal transfer between the lean absorbent and the loaded absorbent.

15. The system of claim 14, wherein the closed-loop geothermal heating system is configured to receive the loaded absorbent from the heat exchanger.

16. The system of claim 13, further comprising:
an interstage cooler configured to reduce a temperature of the lean absorbent in the absorber with cooling water; and
a closed-loop geothermal cooling system configured to reduce a temperature of the cooling water prior to circulating the cooling water to the interstage cooler.

17. The system of claim 16, wherein closed-loop geothermal heating system is located at a depth below a surface of the earth greater than a depth of the closed-loop geothermal cooling system.

18. The system of claim 13, wherein the closed-loop geothermal system circulates the loaded absorbent in the piping in the earth formation.

19. A method of removing carbon dioxide from a carbon dioxide-containing gas, the method comprising:
absorbing carbon dioxide from the carbon dioxide-containing gas in an absorber with a lean absorbent to form a loaded absorbent;
circulating the loaded absorbent in a closed-loop geothermal heating system to increase a temperature of the loaded absorbent using geothermal energy and form a heated loaded absorbent; and
circulating the heated loaded absorbent from the closed-loop geothermal heating system to a regenerator.

20. The method of claim 19, further comprising circulating a working fluid associated with the absorber or the regenerator to a closed-loop geothermal cooling system to reduce a temperature of the working fluid, the closed-loop geothermal cooling system located a depth below a surface of an earth formation less than a depth of the closed-loop geothermal heating system.
